(19) United States
(12) Patent Application Publication
(10) Pub. No.: US 2024/0078442 A1
(43) Pub. Date: Mar. 7, 2024

(54) SELF-DEVELOPMENT OF RESOURCES IN MULTI-MACHINE ENVIRONMENT

(71) Applicant: INTERNATIONAL BUSINESS MACHINES CORPORATION, ARMONK, NY (US)

(72) Inventors: Saraswathi Sailaja Perumalla, Visakhapatnam (IN); Sarbajit K. Rakshit, Kolkata (IN); Venkata Ratnam Alubelli, Visakhapatnam (IN)

(21) Appl. No.: 17/930,260

(22) Filed: Sep. 7, 2022

(51) Int. Cl. G06N 5/02; B25J 9/16

(52) U.S. Cl. CPC G06N 5/022; B25J 9/1671

(57) ABSTRACT

An embodiment for self-development of resources is provided. The embodiment may include receiving data relating to an activity and a first robotic device assigned to perform the activity. The embodiment may also include creating a knowledge corpus of a second set of one or more robotic devices capable of performing the activity. The embodiment may further include executing a digital twin simulation of a digital twin model of the first robotic device performing the activity. The embodiment may also include in response to determining the first robotic device is unable to complete the activity without incident, identifying within the second set of one or more robotic devices a most comparable robotic device to the first robotic device. The embodiment may further include predicting a modification of the first robotic device. The embodiment may also include attaching one or more resources printed by a 3D printer to the first robotic device.

### BACKGROUND

The present invention relates generally to the field of computing, and more particularly to a system for self-development of resources in a multi-machine environment.

Machines, such as robots, are currently used to perform a wide variety of activities in an industrial environment. Some of these activities were previously exclusively performed by humans (e.g., repetitive tasks on a manufacturing assembly line), whereas other activities require heavy machinery to lift and/or move objects. Machines enable organizations, including manufacturers and construction companies, to carry out a wide variety of activities more seamlessly than humans, getting work done faster and with minimum wasted effort. These machines have differing skills and capabilities, and can perform activities individually and/or collaboratively. As automation becomes commonplace, the demand for machines and robotic technology is expected to increase in the coming decades.

### SUMMARY

According to one embodiment, a method, computer system, and computer program product for self-development of resources in a multi-machine environment is provided. The embodiment may include receiving real-time data relating to an activity and a first robotic device assigned to perform the activity. The embodiment may also include creating an AI knowledge corpus of a second set of one or more robotic devices capable of performing the activity based on historical data relating to the activity. The embodiment may further include executing a digital twin simulation of a digital twin model of the first robotic device performing the activity. The embodiment may also include in response to determining the first robotic device is not able to complete each step of the activity without incident, identifying within the second set of one or more robotic devices a most comparable robotic device to the first robotic device. The embodiment may further include predicting a modification of the first robotic device based on one or more differences between the most comparable robotic device and the first robotic device. The embodiment may also include attaching one or more resources printed by a 3D printer to the first robotic device in the multi-machine environment based on the predicted modification.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary computing environment according to at least one embodiment.

FIG. 2 illustrates an operational flowchart for self-development of resources in a multi-machine environment in a resource development process according to at least one embodiment.

FIG. 3 is an exemplary diagram depicting robotic devices before and after the self-development of a resource according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Embodiments of the present invention relate to the field of computing, and more particularly to a system for self-development of resources in a multi-machine environment. The following described exemplary embodiments provide a system, method, and program product to, among other things, determine whether a first robotic device is able to complete each step of an activity without incident and, accordingly, print and attach one or more resources to the first robotic device in the multi-machine environment. Therefore, the present embodiment has the capacity to improve industrial machine technology by increasing the capabilities of a robotic device with insufficient resources in any multi-machine environment.

As previously described, machines, such as robots, are currently used to perform a wide variety of activities in an industrial environment. Some of these activities were previously exclusively performed by humans (e.g., repetitive tasks on a manufacturing assembly line), whereas other activities require heavy machinery to lift and/or move objects. Machines enable organizations, including manufacturers and construction companies, to carry out a wide variety of activities more seamlessly than humans, getting work done faster and with minimum wasted effort. These machines have differing skills and capabilities, and can perform activities individually and/or collaboratively. As automation becomes commonplace, the demand for machines and robotic technology is expected to increase in the coming decades. When a robotic device is performing an activity, the robotic device may not have adequate resources to carry out the activity effectively. For example, the robotic device may be immobile and/or the grippers of the robotic device may not be able to handle the weight of an object. This problem is typically addressed by deploying a mobile robotic device to gather information and determine the condition of an industrial machine by analyzing sensor data and predicting a maintenance action for the industrial machine. However, predicting a maintenance action for the industrial machine fails to actively allocate a required resource to the robotic device to successfully perform the activity.

It may therefore be imperative to have a system in place to dynamically create and provide additional resources to the robotic device so that the activity may be effectively performed in the multi-machine environment. Thus, embodiments of the present invention may provide advantages including, but not limited to, dynamically creating and providing additional resources to the robotic device to perform the activity effectively, self-developing additional resources, and utilizing 3D printing to create the additional resources. The present invention does not require that all advantages need to be incorporated into every embodiment of the invention.

According to at least one embodiment, in a multi-machine environment of robotic devices, real-time data relating to an activity and a first robotic device assigned to perform the activity may be received in order to create an AI knowledge corpus of a second set of one or more robotic devices capable of performing the activity based on historical data. Upon creating the AI knowledge corpus, a digital twin simulation of a digital twin model of the first robotic device performing the activity may be executed so that it may be determined whether the first robotic device is able to complete each step of the activity without incident based on the digital twin simulation. In response to determining the first robotic device is not able to complete each step of the activity without incident, a most comparable robotic device to the first robotic device may be identified within the second set of the one or more robotic devices such that a modification of the first robotic device may be predicted based on one or more differences between the most comparable robotic device and the first robotic device. The prediction may be verified by executing an updated digital twin simulation of a modified version of the first robotic device having one or more resources performing the activity. Then, the one or more resources may be printed by a 3D printer and attached to the first robotic device in the multi-machine environment based on the predicted modification. According to at least one embodiment, the resource may be an additional accessory (e.g., a gripper or counterweight). According to at least one other embodiment, the resource may be a modified component of a pre-existing component of the first robotic device.

The present invention may be a system, a method, and/or a computer program product at any possible technical detail level of integration. The computer program product may include a computer readable storage medium (or media) having computer readable program instructions thereon for causing a processor to carry out aspects of the present invention.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method, and program product to determine whether a first robotic device is able to complete each step of an activity without incident and, accordingly, print and attach one or more resources to the first robotic device in the multi-machine environment.

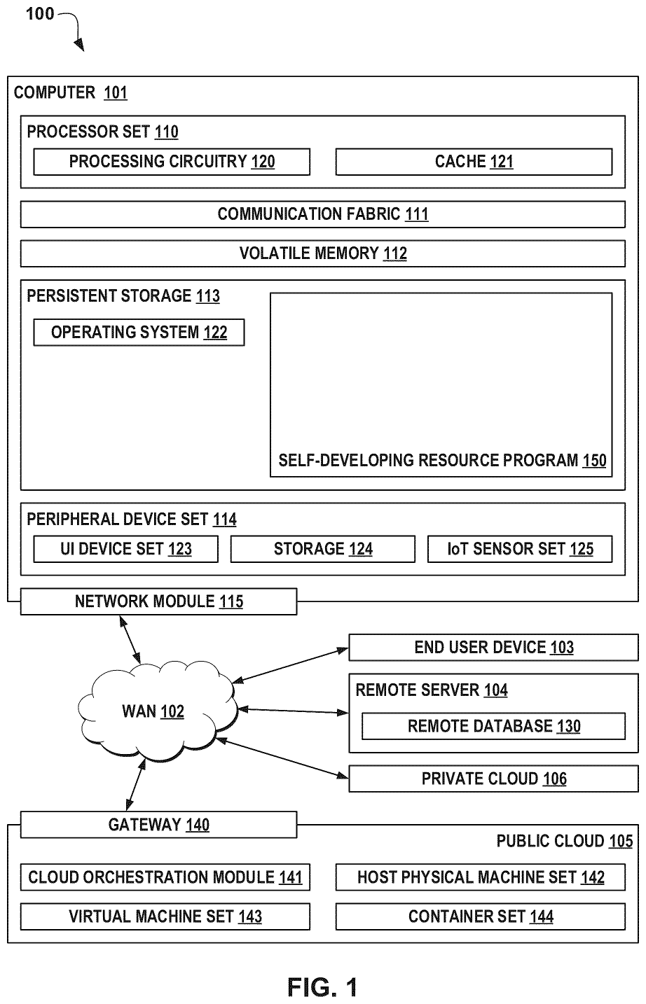

Referring to FIG. 1, an exemplary computing environment 100 is depicted, according to at least one embodiment. Computing environment 100 contains an example of an environment for the execution of at least some of the computer code involved in performing the inventive methods, such as a self-developing resource program 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory 112 is characterized by random access, but this is not required unless affirmatively indicated. In computer 101, the volatile memory 112 is located in a single package and is internal to computer 101, but, alternatively or additionally, the volatile memory 112 may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage 113 allows writing of data, deletion of data and re-writing of data. Some familiar forms of persistent storage 113 include magnetic disks and solid state storage devices. Operating system 122 may take several forms, such as various known proprietary operating systems or open source Portable Operating System Interface type operating systems that employ a kernel. The code included in block 150 typically includes at least some of the computer code involved in performing the inventive methods.

Peripheral device set 114 includes the set of peripheral devices of computer 101. Data communication connections between the peripheral devices 114 and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database), this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector. Peripheral device set 114 may also include a machine, a robotic device, and/or any other device for performing labor related tasks.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN 102 and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments the private cloud 106 may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

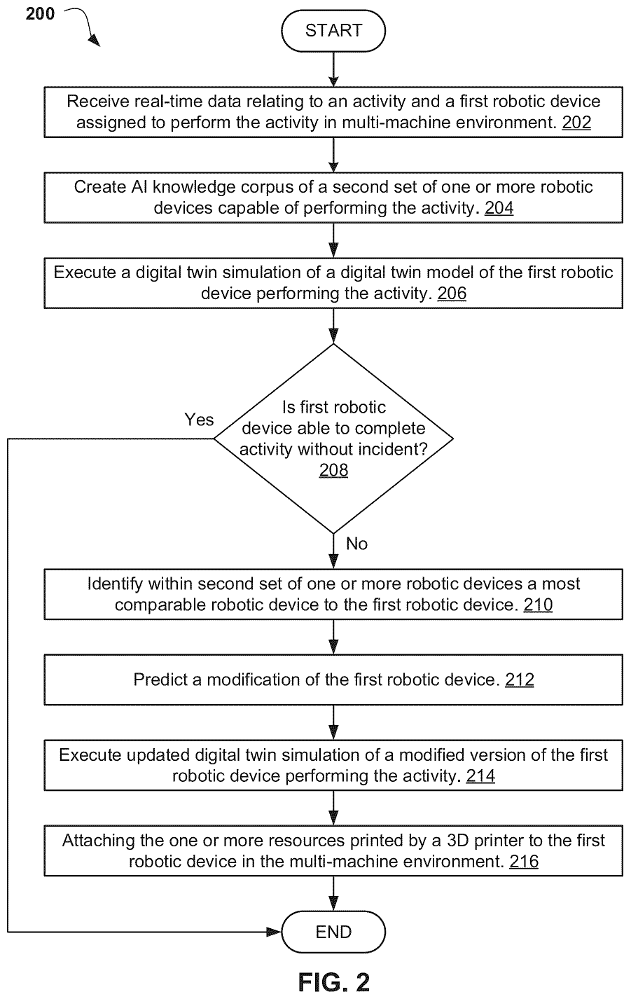

According to the present embodiment, the self-developing resource program 150 may be a program capable of receiving real-time data relating to an activity and a first robotic device assigned to perform the activity in a multi-machine environment, determining whether the first robotic device is able to complete each step of the activity without incident, printing and attaching one or more resources to the first robotic device in the multi-machine environment, dynamically creating and providing additional resources to a robotic device to perform the activity effectively, self-developing additional resources, and utilizing 3D printing to create the additional resources. Furthermore, notwithstanding depiction in computer 101, the self-developing resource program 150 may be stored in and/or executed by, individually or in any combination, end user device 103, remote server 104, public cloud 105, and private cloud 106. The self-developing resource method is explained in further detail below with respect to FIG. 2.

Referring now to FIG. 2, an operational flowchart for self-development of resources in a multi-machine environment in a resource development process 200 is depicted according to at least one embodiment. At 202, the self-developing resource program 150 receives the real-time data relating to the activity and the first robotic device assigned to perform the activity.

The real-time data relating to the activity may include the type of activity to be performed in the multi-machine environment. Examples of an activity may include, but are not limited to, assembling objects in a manufacturing facility, moving objects at a construction site, and transporting objects from one location to another, (e.g., moving a product from an assembly line to a shipping area). The real-time data relating to the activity may also include one or more objects associated with the activity. Examples of an object may include, but are not limited to, a shipping container, an automobile, a device on an assembly line, construction materials, and/or any object capable of being moved from a source to a destination, i.e., from one location to another location. The real-time data relating to the activity may further include the time required to complete the activity. For example, the activity may typically take two hours to complete.

The real-time data relating to the first robotic device assigned to perform the activity may include a particular robotic device to perform the activity. The real-time data relating to the first robotic device may also include parts of the first robotic device. Examples of a part include, but are not limited to, a detachable part (e.g., a gripper), an arm, wheels, and/or a counterweight. It may be appreciated that “parts” and “resources” are used interchangeably herein.

According to at least one embodiment, a user may specify the type of activity to be performed via a user interface (UI) on a device of the user. The user may be an individual who has background knowledge of the activity, such as a foreman or manager of an activity. For example, the user may specify that the activity to be performed is assembling an automobile on an assembly line. Based on the type of activity, the self-developing resource program 150 may obtain the one or more objects associated with the activity, the time required to complete the activity, and the first robotic device assigned to perform the activity. Continuing the example above, when the user specifies the activity to be performed is assembling the automobile on the assembly line, the self-developing resource program 150 may obtain information that the objects are parts of the automobile (i.e., a hood, door, windshield etc.), the time required to complete the activity is two hours, and the first robotic device assigned to perform the activity is a robotic device with a gripper. This data may be used in the digital twin simulation and the updated digital twin simulation, described in further detail below with respect to steps 206 and 214, respectively.

Then, at 204, the self-developing resource program 150 creates the AI knowledge corpus of the second set of the one or more robotic devices capable of performing the activity. The AI knowledge corpus is created based on the historical data relating to the activity. The historical data may include a plurality of different types of robotic devices that have successfully (i.e., without incident) performed the assigned activity in the past. The historical data may also include the strength required to perform the activity, the dimensions of the various parts of the second set of the one or more robotic devices (e.g., gripper and/or arm), the time required to successfully complete the activity, and/or the location of the activity. For example, where the assigned activity is the assembling of exercise equipment in a manufacturing facility, the AI knowledge corpus may be created with the second set of robotic devices as robots A, B, C, D, and E as being capable of performing the activity in an indoor manufacturing facility, where robots A, B, C, D, and E have a 12 inch gripper, 6 inch arm, and a 24 inch base with wheels, and are each able to perform the activity in two hours. The AI knowledge corpus may process this information and may be stored in a database, such as remote database 130. It may be appreciated that the example described above is not intended to be limiting, and that in embodiments of the present invention the second set of robotic devices may be a variety of other robotic devices with different specifications and capabilities.

Next, at 206, the self-developing resource program 150 executes the digital twin simulation of the digital twin model of the first robotic device performing the activity. The self-developing resource program 150 may use known techniques to create the digital twin model of the first robotic device, and this digital twin model may be used in the digital twin simulation. The digital twin of the first robotic device used in the simulation may have the same specifications the first robotic device has in the real-world. Additionally, the digital twin of the first robotic device used in the simulation may also have the same materials the first robotic device is made of in the real-world. For example, the arm of the first robotic device may be made of a metal, such as titanium, and the gripper may be made of the same or different type of metal (e.g., aluminum), or the gripper may be made of plastic. In this manner, maximum accuracy may be preserved during the digital twin simulation. The digital twin simulation may be executed in accordance with the typical range of movements the first robotic device assigned to perform the activity makes in the real-world while performing the activity. For example, when the activity is assembling automobile parts on an assembly line, the range of movements may include picking up a door and a hood cover and placing them on a chassis.

Then, at 208, the self-developing resource program 150 determines whether the first robotic device is able to complete each step of the activity without incident. The determination may be made based on the digital twin simulation. As described above with respect to step 206, the self-developing resource program 150 executes the digital twin simulation of the digital twin model of the first robotic device performing the activity, during which the first robotic device may perform the range of motions the first robotic device makes in the real-world. During the digital twin simulation, an incident may occur due to the presence of an insufficient resource associated with the first robotic device. Examples of an incident include, but are not limited to, a dropping and/or breaking of the one or more objects, a deformity in at least one part of the first robotic device (e.g., bending, twisting, and/or melting), a toppling of the first robotic device, and/or a failure to complete the activity within a typical timeframe. For example, the gripper made of plastic may melt when handling a hot object and/or where the internal temperature of the manufacturing facility reaches a threshold temperature for melting. In another example, the gripper may drop an object that is either too heavy to carry or too large to grip properly. In yet another example, the first robotic device may be immobile, causing the delay in completing the activity.

In response to determining the first robotic device is not able to complete each step of the activity without incident (step 208, “No” branch), the resource development process 200 proceeds to step 210 to identify within the second set of the one or more robotic devices the most comparable robotic device to the first robotic device. In response to determining the first robotic device is able to complete each step of the activity without incident (step 208, “Yes” branch), the resource development process 200 ends.

Next, at 210, the self-developing resource program 150 identifies within the second set of the one or more robotic devices the most comparable robotic device to the first robotic device. As described above with respect to step 204, the AI knowledge corpus may be created with the second set of robotic devices that are capable of performing the activity.

According to at least one embodiment, the most comparable device in the second set of the one or more robotic devices may be identified based on a greatest number of parts in common with the first robotic device. For example, the second set of the one or more robotic devices may include robots A, B, and C, where robot A has an arm, a gripper, and a base, and robot B has a base, an arm, and a claw, and robot C has a base and a claw. Continuing the example, where the first robotic device includes an arm, a gripper, and a base, the most comparable robotic device may be robot A, since robot A and the first robotic device have three parts in common.

Then, at 212, the self-developing resource program 150 predicts the modification of the first robotic device. The modification is predicted based on the one or more differences between the most comparable robotic device and the first robotic device. According to at least one embodiment, the one or more differences may be differences in the parts themselves. For example, where robot A is the most comparable robotic device to the first robotic device and robot A has a base, an arm and a gripper, and where the first robotic device has a base and an arm (i.e., 2 of 3 parts in common), the difference between the most comparable robotic device and the first robotic device is the absence of the gripper in the first robotic device. In this embodiment, the predicted modification of the first robotic device may be to add the missing resource (e.g., the gripper) to the first robotic device.

According to at least one other embodiment, the one or more differences may be differences in the specifications of the parts. For example, where robot A is the most comparable robotic device to the first robotic device and robot A has a base, an arm and a gripper made of titanium, and where the first robotic device has a base, an arm, and a gripper made of plastic (i.e., 3 of 3 parts in common), the difference between the most comparable robotic device and the first robotic device is the material used for the gripper. Continuing the example above, where robot A is the most comparable robotic device to the first robotic device and robot A has a base, an arm and a gripper having a diameter of 6 inches, and where the first robotic device has a base, an arm, and a gripper having a diameter of 4 inches (i.e., 3 of 3 parts in common), the difference between the most comparable robotic device and the first robotic device is the size of the gripper. In this embodiment, the predicted modification of the first robotic device may be to substitute the resource of the most comparable device (e.g., the titanium gripper) for the insufficient resource of the first robotic device (e.g., the plastic gripper). It may be appreciated that the examples described above are not intended to be limiting, and that in embodiments of the present invention the resources and specifications of the first robotic device and the most comparable robotic device may be different from the resources and specifications described above.

Next, at 214, the self-developing resource program 150 attaches the one or more resources printed by the 3D printer to the first robotic device in the multi-machine environment. The one or more resources are printed and attached based on the predicted modification. Examples of a resource attached to the first robotic device include, but are not limited to, a mobility mechanism (e.g., wheels attached to the base of the first robotic device to make the first robotic device mobile), a counterweight (e.g., when the first robotic device topples during the digital twin simulation), a gripper, and/or an arm.

According to at least one embodiment, where the predicted modification of the first robotic device may be to add the missing resource to the first robotic device, the 3D printer may print the one or more missing resources. In this embodiment, the one or more missing resources may be additional accessories to be attached to the first robotic device. For example, where robot A is the most comparable robotic device to the first robotic device and robot A has a base with wheels, an arm and a gripper, and where the first robotic device has a base with no wheels and an arm (i.e., 2 of 4 parts in common), the 3D printer may print the wheels for the base and the gripper. According to at lest one other embodiment, where the predicted modification of the first robotic device may be to substitute the resource of the most comparable device for the insufficient resource of the first robotic device, the 3D printer may print the one or more substituted resources. In this embodiment, the one or more substituted resources may be modified accessories to be attached to the first robotic device. For example, where robot A is the most comparable robotic device to the first robotic device and robot A has a base, an arm and a titanium gripper having a diameter of 6 inches, and where the first robotic device has a base, an arm, and a plastic gripper having a diameter of 4 inches (i.e., 3 of 3 parts in common), the 3D printer may print the titanium gripper having a diameter of 6 inches. The 3D printer may either be embedded in the first robotic device or external to the first robotic device in the multi-machine environment.

Once the one or more resources are printed, the one or more resources may be attached to the first robotic device in the multi-machine environment. According to at least one embodiment, at least one other robot (i.e., a robot other than the first robotic device assigned to perform the activity) in the multi-machine environment may attach the one or more resources to the first robotic device, such as when the first robotic device is unable to attach the one or more resources to itself. According to at least one other embodiment, the first robotic device may attach the one or more resources to itself, such as when the first robotic device is able to attach the one or more resources to itself. For example, when the first robotic device already has a gripper or claw prior to the printing, the first robotic device may be able to attach the one or more resources to itself. It may be appreciated that the examples described above are not intended to be limiting, and that in embodiments of the present invention the resources and specifications of the first robotic device and the most comparable robotic device may be different from the resources and specifications described above.

Then, at 216, the self-developing resource program 150 executes the updated digital twin simulation of the modified version of the first robotic device having the one or more resources performing the activity. The updated digital twin simulation may validate the prediction made in step 212 and, according to at least one embodiment, may be executed prior to the printing and attachment of the one or more resources. The updated digital twin simulation may perform the same range of motions as in the digital twin simulation. In response to determining the modified version of the first robotic device is not able to complete each step of the activity without incident, the execution of the updated digital twin simulation may be iterated with a different resource from the predicted one or more resources. For example, where the predicted modification of the first robotic device is a gripper with a diameter of 6 inches, and where in the updated digital twin simulation the modified version of the first robotic device continues to drop and/or break the object, the execution of the updated digital twin simulation may be iterated with a gripper having a larger diameter than 6 inches. The prediction may be validated when the modified version of the first robotic device is able to complete each step of the activity without incident in the updated digital twin simulation.

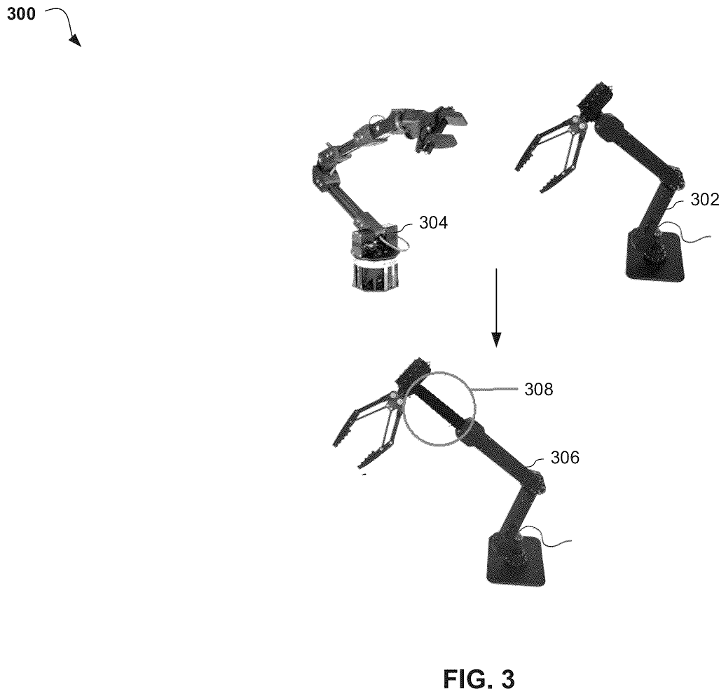

Referring now to FIG. 3, an exemplary diagram 300 depicting robotic devices before and after the self-development of a resource is shown according to at least one embodiment. In the diagram 300, the first robotic device 302 may be assigned to perform the activity in the multi-machine environment and another robotic device 304 may be performing a different activity. In response to determining the first robotic device 302 is unable to complete each step of the activity, the self-developing resource program 150 may predict a modified first robotic device 306 having the one or more predicted resources. In the embodiment illustrated in FIG. 3, the predicted resource may be the arm 308. The arm 308 may be printed by the 3D printer embedded in or external to the first robotic device 302 and may be attached by the other robotic device 304 to form the modified first robotic device 306 that is now able to complete the activity.

It may be appreciated that FIGS. 2 and 3 provide only an illustration of one implementation and do not imply any limitations with regard to how different embodiments may be implemented. Many modifications to the depicted environments may be made based on design and implementation requirements.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-based method of self-developing resources in a multi-machine environment, the method comprising:
receiving real-time data relating to an activity and a first robotic device assigned to perform the activity;
creating an AI knowledge corpus of a second set of one or more robotic devices capable of performing the activity based on historical data relating to the activity;
executing a digital twin simulation of a digital twin model of the first robotic device performing the activity;
determining whether the first robotic device is able to complete each step of the activity without incident based on the digital twin simulation;
in response to determining the first robotic device is not able to complete each step of the activity without incident, identifying within the second set of one or more robotic devices a most comparable robotic device to the first robotic device;
predicting a modification of the first robotic device based on one or more differences between the most comparable robotic device and the first robotic device; and
attaching one or more resources printed by a 3D printer to the first robotic device in the multi-machine environment based on the predicted modification.

2. The computer-based method of claim 1, further comprising:
executing an updated digital twin simulation of a modified version of the first robotic device having the one or more resources performing the activity to validate the prediction.

3. The computer-based method of claim 2, wherein executing the updated digital twin simulation further comprises:
iterating the execution of the updated digital twin simulation with a different resource in response to determining the modified version of the first robotic device is not able to complete each step of the activity without incident.

4. The computer-based method of claim 1, wherein the 3D printer is embedded in the first robotic device.

5. The computer-based method of claim 1, wherein the most comparable robotic device in the second set of the one or more robotic devices is identified based on a greatest number of parts in common with the first robotic device.

6. The computer-based method of claim 1, wherein the one or more resources printed by the 3D printer are one or more additional accessories that are attached to the first robotic device by at least one other robot in the multi-machine environment.

7. The computer-based method of claim 1, wherein the resource attached to the first robotic device is selected from a group consisting of a mobility mechanism, a counterweight, a gripper, and an arm.

8. A computer system, the computer system comprising:
one or more processors, one or more computer-readable memories, one or more computer-readable tangible storage medium, and program instructions stored on at least one of the one or more computer-readable tangible storage medium for execution by at least one of the one or more processors via at least one of the one or more computer-readable memories, wherein the computer system is capable of performing a method comprising:
receiving real-time data relating to an activity and a first robotic device assigned to perform the activity;
creating an AI knowledge corpus of a second set of one or more robotic devices capable of performing the activity based on historical data relating to the activity;
executing a digital twin simulation of a digital twin model of the first robotic device performing the activity;
determining whether the first robotic device is able to complete each step of the activity without incident based on the digital twin simulation;
in response to determining the first robotic device is not able to complete each step of the activity without incident, identifying within the second set of one or more robotic devices a most comparable robotic device to the first robotic device;
predicting a modification of the first robotic device based on one or more differences between the most comparable robotic device and the first robotic device; and
attaching one or more resources printed by a 3D printer to the first robotic device in the multi-machine environment based on the predicted modification.

9. The computer system of claim 8, further comprising:
executing an updated digital twin simulation of a modified version of the first robotic device having the one or more resources performing the activity to validate the prediction.

10. The computer system of claim 9, wherein executing the updated digital twin simulation further comprises:
iterating the execution of the updated digital twin simulation with a different resource in response to determining the modified version of the first robotic device is not able to complete each step of the activity without incident.

11. The computer system of claim 8, wherein the 3D printer is embedded in the first robotic device.

12. The computer system of claim 8, wherein the most comparable robotic device in the second set of the one or more robotic devices is identified based on a greatest number of parts in common with the first robotic device.

13. The computer system of claim 8, wherein the one or more resources printed by the 3D printer are one or more additional accessories that are attached to the first robotic device by at least one other robot in the multi-machine environment.

14. The computer system of claim 8, wherein the resource attached to the first robotic device is selected from a group consisting of a mobility mechanism, a counterweight, a gripper, and an arm.

15. A computer program product, the computer program product comprising:
one or more computer-readable tangible storage medium and program instructions stored on at least one of the one or more computer-readable tangible storage medium, the program instructions executable by a processor capable of performing a method, the method comprising:
receiving real-time data relating to an activity and a first robotic device assigned to perform the activity;
creating an AI knowledge corpus of a second set of one or more robotic devices capable of performing the activity based on historical data relating to the activity;
executing a digital twin simulation of a digital twin model of the first robotic device performing the activity;
determining whether the first robotic device is able to complete each step of the activity without incident based on the digital twin simulation;
in response to determining the first robotic device is not able to complete each step of the activity without incident, identifying within the second set of one or more robotic devices a most comparable robotic device to the first robotic device;
predicting a modification of the first robotic device based on one or more differences between the most comparable robotic device and the first robotic device; and
attaching one or more resources printed by a 3D printer to the first robotic device in the multi-machine environment based on the predicted modification.

16. The computer program product of claim 15, further comprising:
executing an updated digital twin simulation of a modified version of the first robotic device having the one or more resources performing the activity to validate the prediction.

17. The computer program product of claim 16, wherein executing the updated digital twin simulation further comprises:
iterating the execution of the updated digital twin simulation with a different resource in response to determining the modified version of the first robotic device is not able to complete each step of the activity without incident.

18. The computer program product of claim 15, wherein the 3D printer is embedded in the first robotic device.

19. The computer program product of claim 15, wherein the most comparable robotic device in the second set of the one or more robotic devices is identified based on a greatest number of parts in common with the first robotic device.

20. The computer program product of claim 15, wherein the one or more resources printed by the 3D printer are one or more additional accessories that are attached to the first robotic device by at least one other robot in the multi-machine environment.
